(19) United States
(12) Patent Application Publication
(10) Pub. No.: US 2022/0016964 A1
(43) Pub. Date: Jan. 20, 2022

(54) SYSTEM AND METHOD FOR VEHICLE PROTECTION

(71) Applicant: John Hart, Sammamish, WA (US)

(72) Inventor: John Hart, Sammamish, WA (US)

(21) Appl. No.: 17/377,875

(22) Filed: Jul. 16, 2021

Related U.S. Application Data
(60) Provisional application No. 63/052,949, filed on Jul. 16, 2020.

(51) Int. Cl. B60J 11/06; B60R 19/44

(52) U.S. Cl. CPC B60J 11/06; B60R 19/44

(57) ABSTRACT

A protective cover for a motorized vehicle, the protective cover comprising a formed structure covering substantially all of an outer surface of the motorized vehicle, the formed structure having an outer surface and an inner surface, and integrated connecting means on the formed structure for connecting the formed structure to the outer surface of the motorized vehicle, the integrated connecting means detachably connecting the inner surface of the formed structure to the outer surface of the motorized vehicle, the outer surface of the formed structure having a shape, a color or a texture substantially similar to the outer surface of the motorized vehicle.

### CROSS-REFERENCE TO RELATED APPLICATION

This application claims priority to U.S. Provisional Application No. 63/052,949 filed Jul. 16, 2020, which is hereby incorporated by reference in its entirety.

### FIELD

The present disclosure relates generally to the field of vehicle protection and, in particular but not exclusively, relates to a composite protective covering for protecting the outer surfaces of industrial equipment and other motorized vehicles.

### BACKGROUND

Motorized vehicles and heavy machinery equipment can frequently be damaged from falling debris or suffer from a myriad of abrasions and impact damages in common usage. Various forms and types of protective materials or structures are used to reduce or eliminate the effects of such impacts on such vehicles and equipment. In the case of pick-up trucks, it is common to use a plastic or composite covering to protect the inside of the cargo bed from falling debris and to prevent abrasions and impact damage to the paint or structure of the vehicle. This plastic covering is often called a “Bed Liner” in the application of truck beds while in consumer automobiles such coverings are frequently fitted car mats that are used to protect interior floor carpet. The frequency of damages to such vehicles is often sporadic in nature and in both cases these solutions may also be used to cover existing physical or cosmetic imperfections or damage to improve or alter the appearance and potential value of these vehicles.

On the other hand, the outer portions of construction equipment can suffer far more significant and more frequent physical abuse. Construction equipment, such as hydraulic excavators (e.g., excavators, track hoes, etc.), wheel loaders, dump trucks, manlifts, skid steer loaders, compact track loaders, forklifts and the like are particularly vulnerable to physical damage. More specifically, the counterweights (also referred to as ballast) of excavators, wheel loaders, and forklifts, skid steers and compact track loaders as well as the outermost panels of excavators, which have outer compositions comprised of metal or steel, are both easily scratched, dented, or damaged by impact and abrasion.

A common practice for reducing the visual effect of such damage is to apply spray-on coatings. However, such coatings rarely, if ever, withstand the physical damage suffered by such equipment and ultimately do not reduce or eliminate the physical results of frequent dents and abrasions.

Over time, the owners of some construction equipment and heavy machinery equipment may seek to sell or rent these devices but the appearance of physical damage on them can often prevent or substantially reduce their commercial appeal and value. No effective solution has yet been developed to preserve the structural integrity, visual appearance, composition, and commercial value of such equipment and to provide covering for such damage. Thus, there is a growing need for a solution in the form of a protective liner, cover or a solid protective material or wrap that can be attached over or connected to the outermost areas of on or off-road vehicles and industrial and construction equipment and that provides a physical covering to minimize or eliminate the effect of the damage caused by the type and frequency of physical abuse suffered by such vehicles and equipment while improving their appearance and preserving their resale value.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is an illustration of a protective cover extending over a frontal bumper of a commercial truck in an embodiment.

FIG. 2A is an illustration of a protective cover extending over a counterweight for an industrial excavator in an embodiment.

FIG. 2B is an illustration of a protective cover extending over a side guard of an excavator in an embodiment.

FIG. 2C is an illustration of a protective cover extending over a rear counterweight for an industrial excavator in an embodiment.

FIG. 2D is an illustration of a protective cover extending over a rear side of an industrial excavator in an embodiment.

FIG. 3A is a frontal view of a protective cover extending over a motor grader push block in an embodiment.

FIG. 3B is a side view of a protective cover extending over a motor grader in an embodiment.

FIG. 4A is a frontal view of a protective cover extending over a front bumper of a pickup truck in an embodiment.

FIG. 4B is a right-side view of a protective cover extending over a front bumper of a pickup truck in an embodiment.

FIG. 4C is a left side view of a protective cover extending over a front bumper of a pickup truck in an embodiment.

FIG. 4D is an illustration of a protective cover extending over a rear bumper of a pickup truck in an embodiment.

FIG. 5 is an illustration of a protective cover extending over a rear mounted counterweight for a telescopic material handler in an embodiment.

FIG. 6A is an illustration of a protective cover extending over a counterweight on a wheel loader in an embodiment.

FIG. 6B is an illustration of a protective cover extending over a continuous counterweight for a wheel loader in an embodiment.

FIG. 7 is a flowchart illustrating a method of making a protective cover for a vehicle in an embodiment.

### DETAILED DESCRIPTION

In the description to follow, various aspects of embodiments of a protective covering for use in protecting the outer surfaces of motorized vehicles and industrial equipment will be described, and specific configurations will be set forth. Numerous and specific details are given to provide an understanding of these embodiments. The aspects disclosed herein can be practiced without one or more of the specific details, or with other methods, components, systems, services, etc. In other instances, structures or operations are not shown or described in detail to avoid obscuring relevant inventive aspects.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the features, structures, or characteristics may be combined in any suitable manner in one or more embodiments.

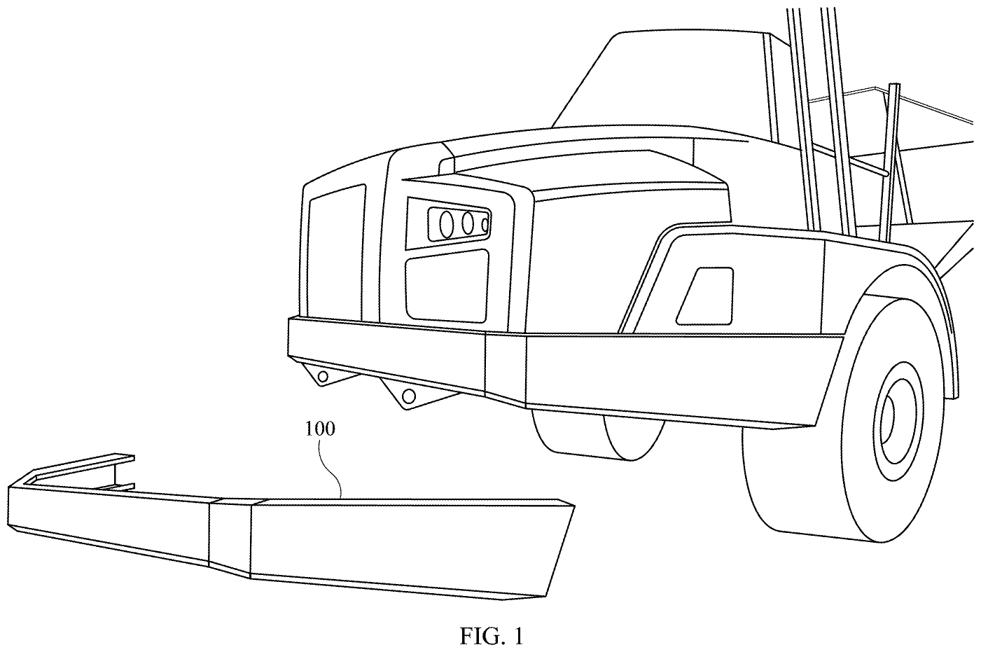

FIG. 1 is an illustration of a protective covering extending over the front bumper of a commercial truck such as an articulated dump truck. The protective covering 100 is comprised of a formed material that is pre-shaped generally in the form of the front bumper on the truck. The purpose of the protective covering is to both protect from and to cover damage on the frontal bumper for the purpose of preserving or extending the useful life of the bumper or enhancing the resale value of the truck. The protective covering 100 is comprised of materials that can generally be formed using a conventional industrial forming process such as 3D printing, plastic injection molding, rotational molding, extrusion blow molding, injection blow molding, reaction injection molding, vacuum casting compression molding, thermoforming or thermomolding. These materials can include plastics of varying types and other composite materials. The formed protective cover 100 has an inner surface and an outer surface. In the illustrated embodiment, the inner surface is shaped to conform to the general shape and structure of the frontal bumper of the truck and includes an extended connecting section for sliding, snapping or form fitting the protective covering 100 onto the bumper. In an alternative embodiment, the protective covering 100 includes a plurality of flanges for establishing a connection to the front bumper. The outer surface of the protective cover 100 can be modified or shaped to present the same or a substantially different appearance on the frontal bumper of a truck such that the appearance may be perceived to be entirely new or unique.

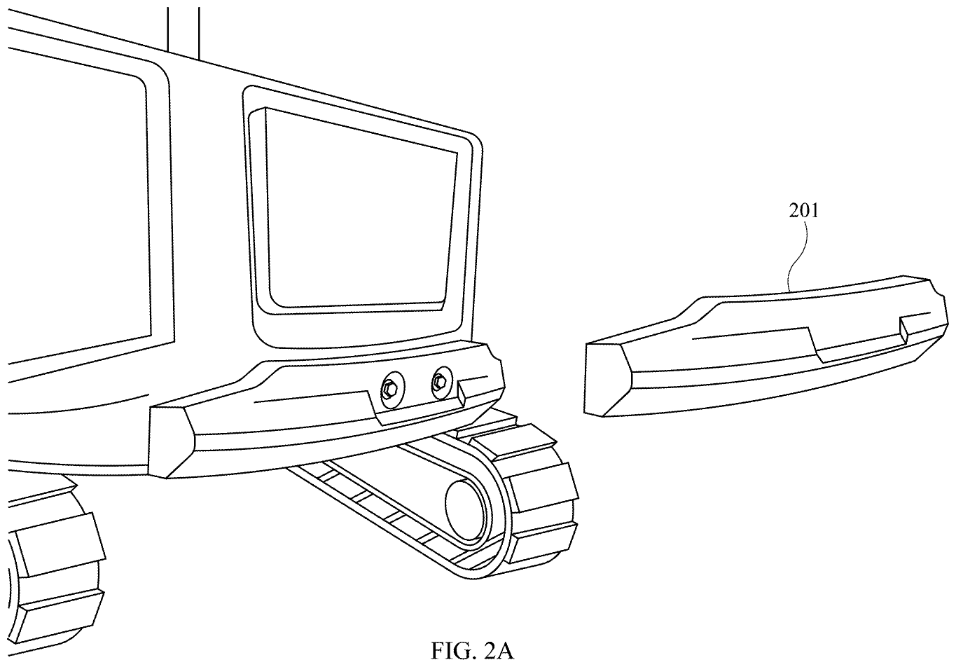

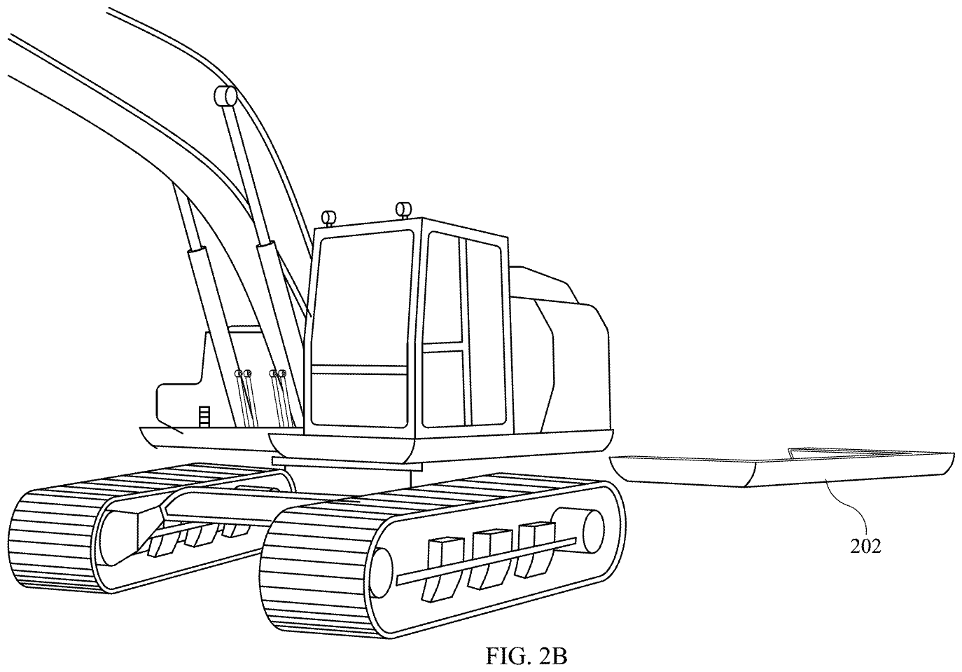

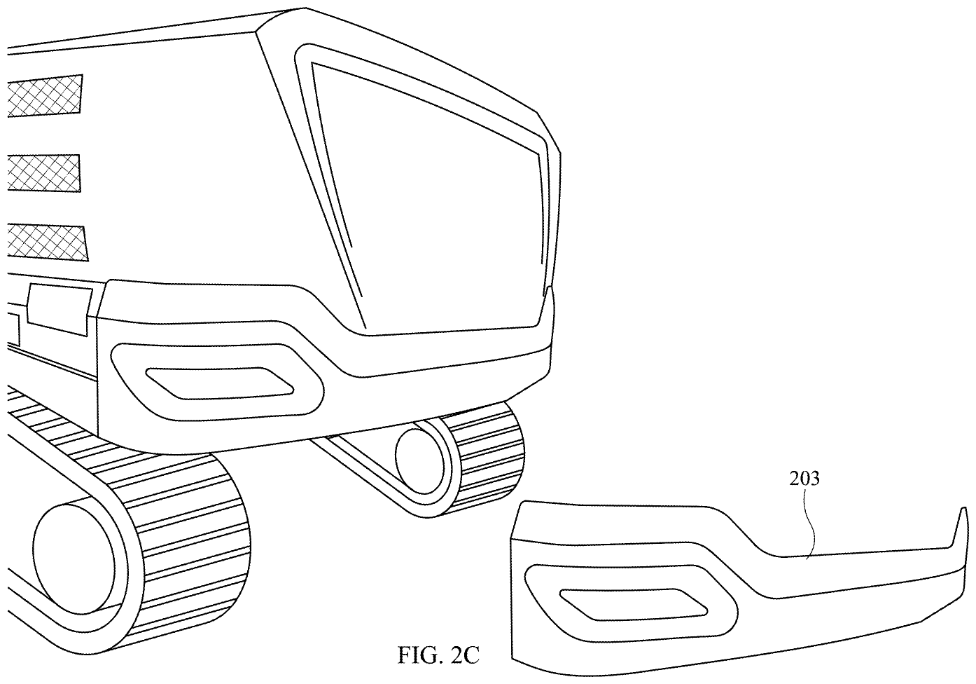

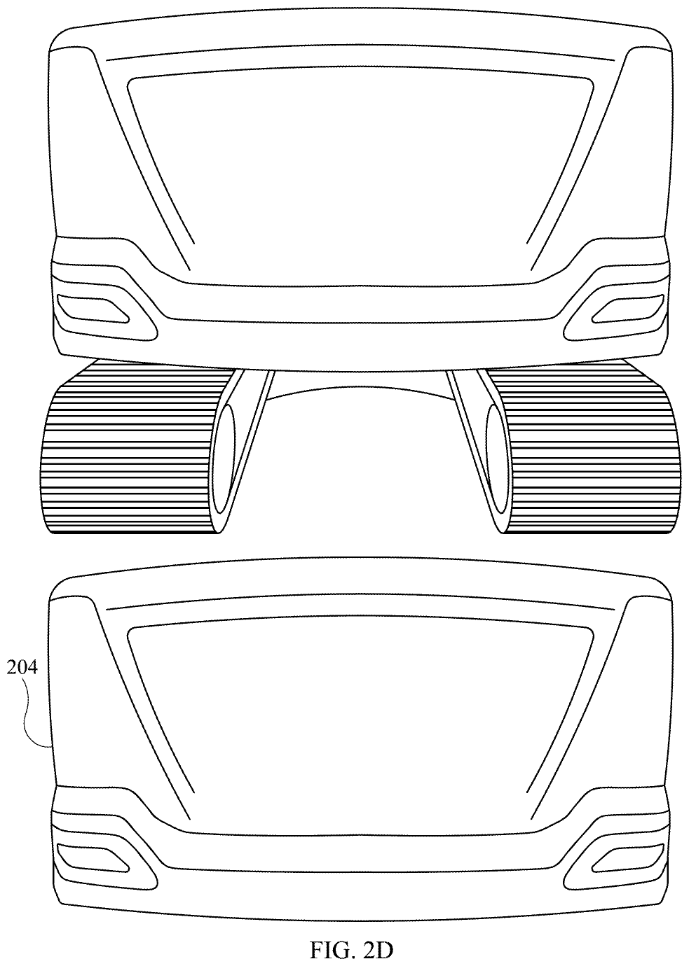

FIG. 2A is an illustration of a protective cover 201 extending over a counterweight of an industrial excavator in an embodiment. In the illustrated embodiment, the protective cover 201 extends lengthwise across the counterweight structure and is formed to connect seamlessly onto the counterweight of the excavator. The connection means used on the protective cover 201 includes one or more integrated flanges, extended portions or sections of the material comprising the formed cover 201 capable of snapping onto the counterweight structure, or other means for connecting formed materials onto industrial structures following product design standards or protocols, such as the Form-Fit-Function (F3) design framework.

As a general matter, the Form-Fit-Function design framework refers to aspects of manufactured parts that match parts to specific needs. Form refers to the shape and appearance of a part, including its weight, size, color, density, and dimensions. Fit refers to the relationship or orientation of a part to another. Function refers to what a given part is meant to do and generally relates the design of a part to a distinct role or action.

With respect to FIG. 2A, the protective cover 201 is comprised of a formed material which is specially structured or adapted for connection onto or over the counterweight of an industrial excavator in this embodiment. By applying the protective cover in this manner, the appearance of physical damage or other material deformations or discolorations appearing on the counterweight of the excavator can be covered or further damage, deformations or discolorations can be prevented to thereby increase the visual appeal and potential resale value of the excavator. Among the range of plastic materials that can be used to create the protective cover 201 for use on an excavator are one or more of the following: Acrylonitrile Butadiene Styrene (ABS), Polystyrene, Acrylic, Polyphenylsulfone (PPSU), Polycarbonate, Polypropylene (PP), or Polyethelene (HDPE) or other plastic compound material alternatives for creating a protective cover 201 for F3 fitment.

FIG. 2B is an illustration of a protective cover 202 extending over a side guard for an excavator in an embodiment. In this illustrated embodiment, the protective covering 202 extends along a lower side guard on three sides of the side guard (i.e., top, side and bottom). The purpose of the protective cover 202 in that position is to cover or protect the side guard from physical damage such as scratches, dents, or other impact indications to preserve the visual appearance of the surface of the side guard. The protective material in this embodiment is comprised of a formed material that may include ABS, PP, HDPE, Acrylic, or other plastic compound material alternatives and which are known by those skilled in the art to be sufficiently durable to be applied to a side guard to cover or attach to the lower portion of an excavator for use in heavy industrial work.

FIG. 2C is an illustration of a protective cover 203 extending over a rear counterweight of an excavator in an embodiment. The inner surface of the cover 203 is formed to have a shape that matches the underlying structure over which it is attached or connected. The outer surface can be formed to have the same or similar structure as the underlying structure or be formed into an alternative shape. The cover 203 is connected or attached to the excavator using one of several alternative connecting means such as extended edges or flanges that connect over and onto the rear counterweight or integrated connecting flanges that hook onto the rear counterweight providing F3 fitment.

FIG. 2D is an illustration of a protective cover 204 extending over the entirety of a rear side of an industrial excavator in an embodiment. In this embodiment, the cover 204 can be comprised of solid opaque material or transparent material that can be shaped using a forming process into a structure that is durable and that can withstand impact damage while still preserving the overall appearance or color of the structure onto which it is attached. The cover 204 can be connected or attached onto a rear counterweight structure using extended sections of the cover 204 or other connecting means that provide connecting strength while also preserving the overall color and appearance of the structure onto which it is attached based on the F3 design framework. The material forming the cover 204 has an inner surface that is shaped to match the underlying structure that is being protected and an outer surface that can preserve the general shape of the covered structure or be formed into an alternative structure that can generally preserve the visual appearance of the excavator in the event of impact damages (e.g., scratches, dents, etc.).

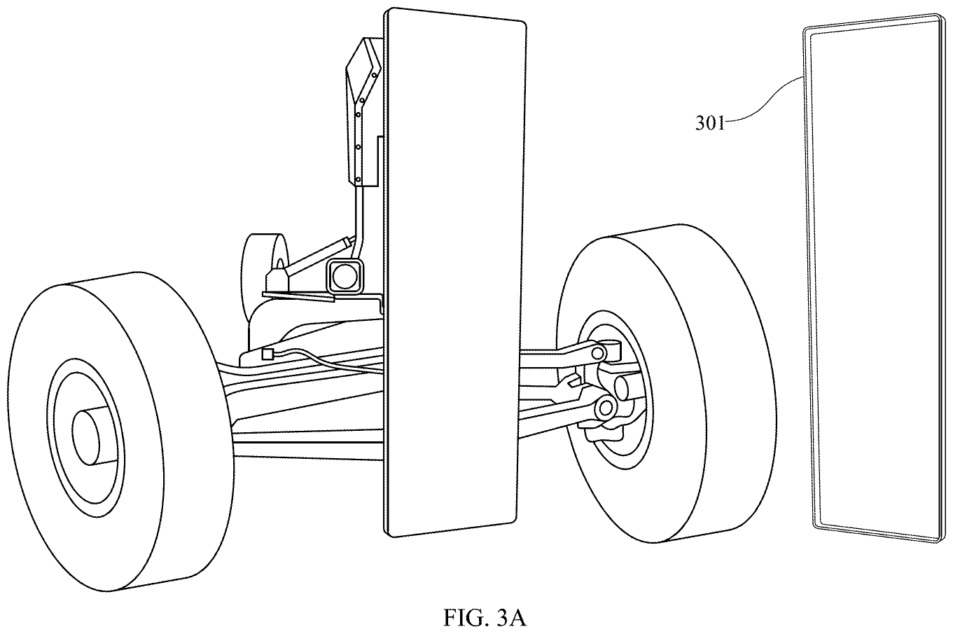

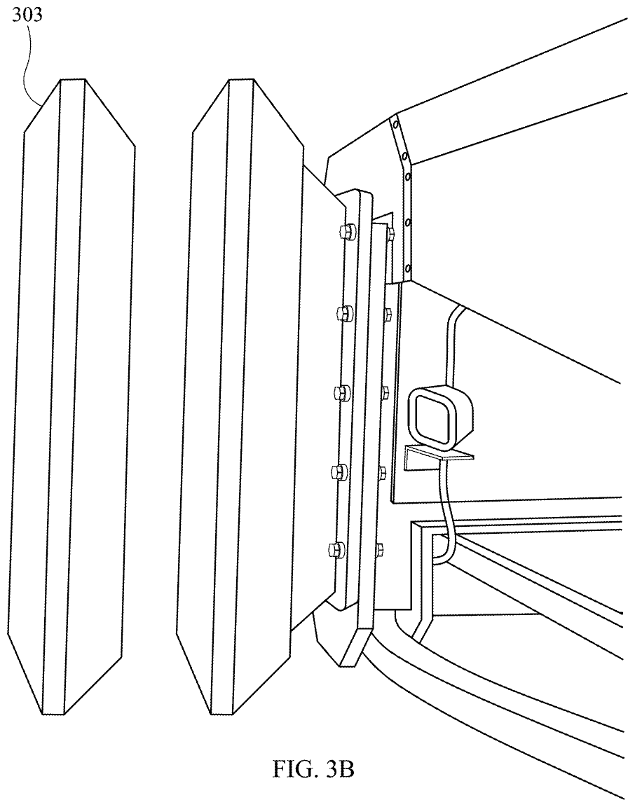

FIG. 3A is a frontal view of a protective cover 301 extending over a forward push block of a motor grader in an embodiment. In this illustrated embodiment, the protective cover 301 is shown extending in a vertical direction and partially covering in a horizontal direction the forward push block of the motor grader. The protective cover 301, as a general matter, is a formed material that is shaped to cover different forms and types of industrial structures for the purpose of preserving appearance and the potential resale value of the commercial vehicle to which it is attached. The protective cover 301 in this embodiment is shown slidably connected and extended over the forward push block of the motor grader. The protective cover 301 in this embodiment can be a formed material created from ABS, PP, HDPE, Acrylic, or other plastic compound material alternatives.

FIG. 3B is a side view of the working side of a motor grader onto which a protective covering 303 has been connected. In this illustrated embodiment, the protective cover 303 is shown extending over the protective portion of the motor grader while also being formed or shaped to allow for the working use of extensions from the rear portion of the protective guard of the motor grader. The formed material used for the protective cover 303 enables and supports custom structuring or forming around unique structures on portions of industrial motorized vehicles. The connecting means used on the protective structure can include a plurality of flanges, or extended sections of the formed protective cover 303 based on the F3 design framework permitting slidable or snapped-on fitment to establish a non-adjustable connection between a protective cover 303 and the surface of the portion of a motor grader onto which the protective cover 303 is applied.

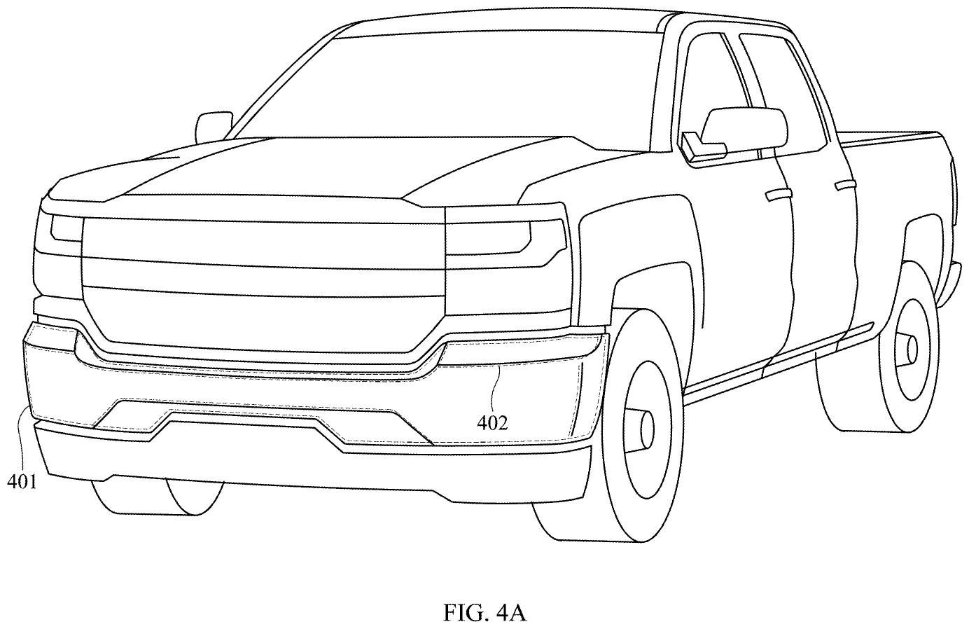

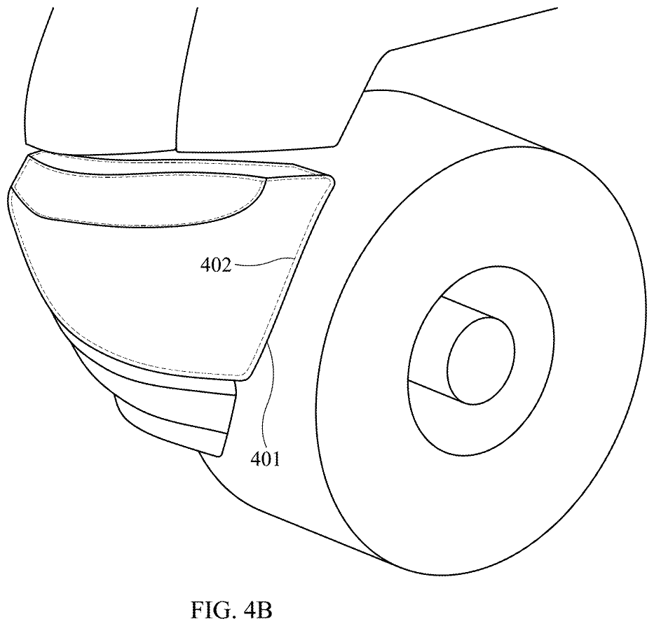

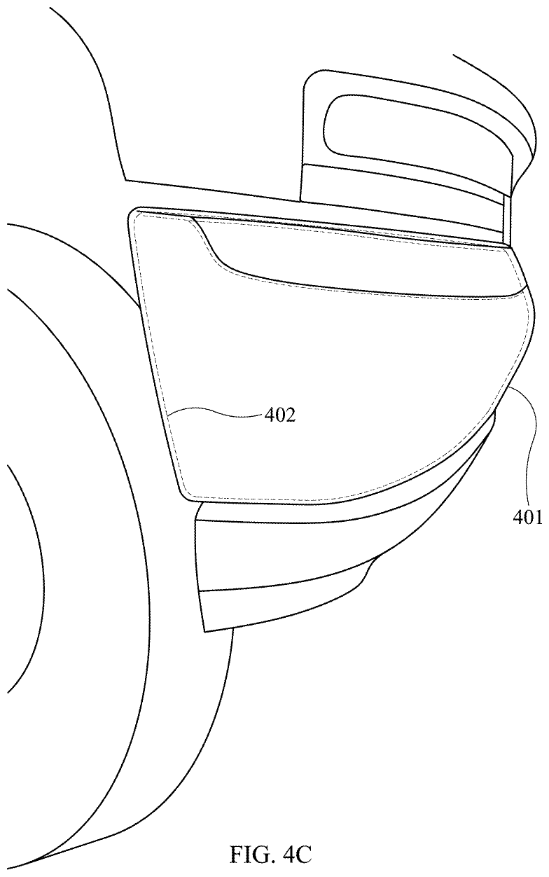

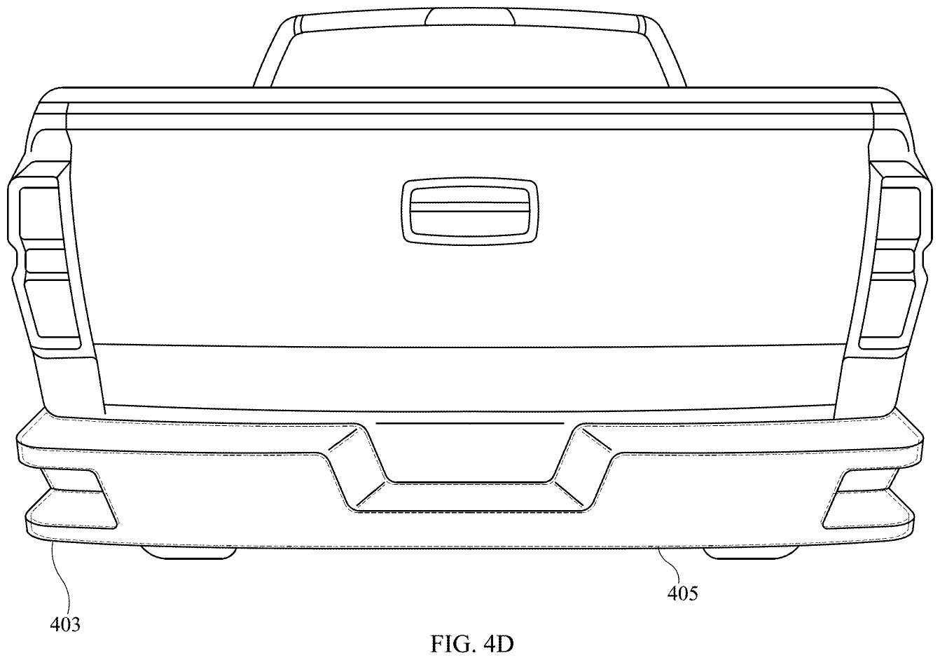

FIG. 4A is an illustration of a frontal view of a protective cover 401 extending over a front bumper 402 of a pickup truck in an embodiment. In the illustrated embodiment, the protective cover 401 is comprised of a formed material and is shaped to be proportional or similar in shape as the outermost object onto which it has been connected, which in this case is the frontal bumper 402 of a pickup truck. The formed material is connected or attached to the front bumper using a plurality of contacts onto the front bumper and provides for F3 fitment. The protective cover 401 is comprised of a formed material including material such as ABS, PP, HDPE, Acrylic, or other plastic compound material alternatives. The protective cover 401 has an inner surface that is shaped like the object onto which it is connected, which in this case is the front bumper of the truck. The outer surface of the protective cover 401 can be shaped to provide an alternative visual appearance or one that is similar in shape and structure of the frontal bumper on the truck. Optionally, a range of specialized adaptations can be applied to the outer surface of the protective cover, which can include signage, reflective material or embossments of desired lettering, reflective materials, or logos. The formed material can also be used as a foundation for integrated mounting solutions permitting for the attachment of external tools such as shovels and picks or vehicle jack solutions allowing temporary yet secure attachment to the formed protective cover 401. In addition to their use on bumpers for pickup trucks, such specialized adaptations can be provided or applied on the protective covers used on a wide variety of vehicles and industrial equipment including those disclosed herein in FIGS. 1-3B and FIGS. 4B-6B.

FIG. 4B is a right-side view of a protective cover 401 extending over the front bumper 402 of a pickup truck in an embodiment. In this illustration it is shown that the protective cover 401 extends completely over the underlying structure and either wraps around or is connected onto the underlying structure. In one embodiment the connecting means can be one or more flange connections, and in alternative embodiments the connecting means may be extended grooves that can be used to slide around and secure the protective cover onto the underlying structure. The protective cover 401 is shaped to have an inner surface that is like the underlying object on which it is attached or covering, while the outer surface can be modified to provide an enhanced appearance or be shaped in some alternative form that further enhances the visual and commercial appeal of the vehicle following the F3 design framework.

FIG. 4C is a left-side view of a protective cover 401 extending over the front bumper 402 of a pickup truck. In this embodiment, the protective cover extends over the underlying protected structure, in this case the front bumper, and can be connected to the bumper using any one of a number of conventional means such as one or more integrated flanges or an extension or extended portion that extends over the bumper and connects behind the structure so as to ensure a firm connection of the protective cover 401 onto the front bumper following the F3 design framework. Again, the protective cover 401 is shaped to have an inner surface that matches or is like the underlying protected structure. The outer surface of the protective cover 401 includes a shape that may be like the underlying structure or one that can be modified to provide a shape that both protects the front bumper from physical abuse such as scratches and dents or other material deformations and covers the outer surface to enhance the visual appearance or commercial value of a vehicle.

FIG. 4D is an illustration of a protective cover 403 extending over the rear bumper 403 of a pickup truck in an embodiment. In this illustrated embodiment, the protective cover 403 extends longitudinally across the surface of the rear bumper and is connected onto or attached onto the rear bumper using a conventional means such as one or more flanges or adapted hinge extensions, which ensure a secure and snug connection onto the rear bumper structure following the F3 design framework. The protective cover 403 in this embodiment is comprised of a formed material such as ABS, PP, HDPE, Acrylic or other plastic compound material alternatives that is durable enough to be formed into a shape that matches the structure of the rear bumper or other structure to which it is attached but that also has an outer surface that can be pre-shaped or modified to an alternative shape that may be similar to or different from the underlying structure to provide the pickup truck with greater visual appeal or commercial resale value.

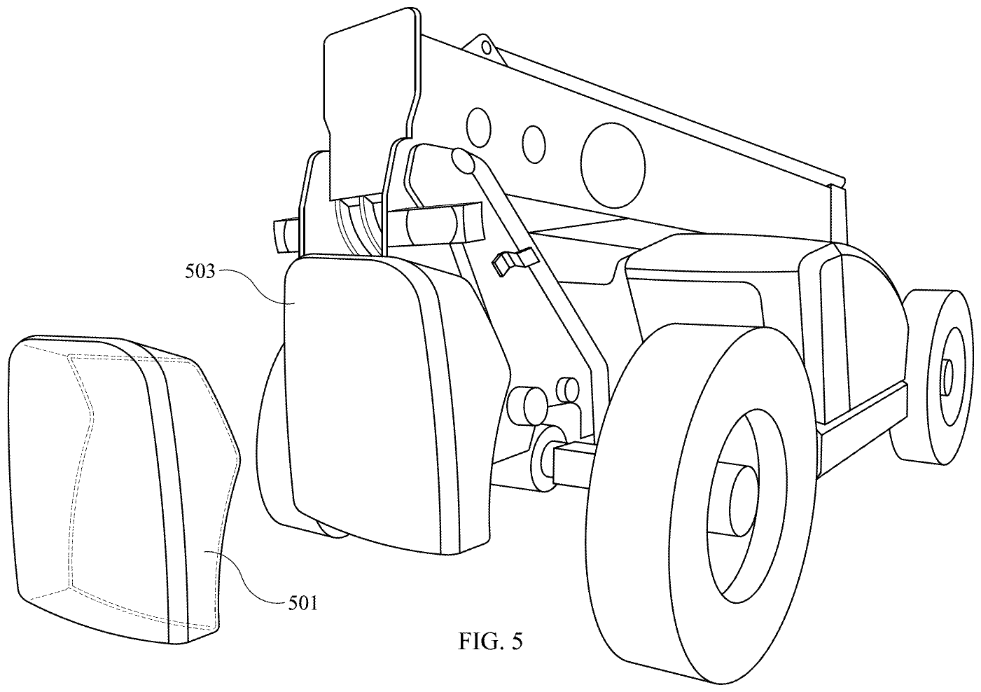

FIG. 5 is an illustration of a protective cover 501 extending over a rear mounted counterweight 503 of a telescopic material handler in an embodiment. A telescopic material handler, more commonly called a reach forklift, is a type of industrial machinery that can often experience significant physical abuse or damage while being used for work on industrial matters. In an alternative embodiment, the protective cover 501 can be extended over a discrete-section counterweight or a continuous counterweight of a conventional forklift to provide a similar level of protective covering that will also preserve the visual and commercial appeal of such a vehicle using substantially the same connecting means as described with respect a telescopic material handler. The protective cover 501 extending across the surface of the rear counterweight 503 of the reach forklift can be applied to protect the underlying structure from physical damage or used to cover the structure to eliminate the visual appearance of physical damage to the structure such as scratches, dents, cracks, or other material imperfections. The protective cover 501 is comprised of a formed polymer material that is shaped to be similar in form to the underlying structure onto which it is connected or attached. The protective cover 501 also has on its edges, any one of a variety of different conventional means for connecting the cover to the structure on the reach forklift. These connecting means can include integrated flanges or extended sections of the structure which extend over and onto the underlying structure of which it has been attached to provide for a secure connection that enables a near seamless appearance of the cover in place of the underlying structure following the F3 design framework.

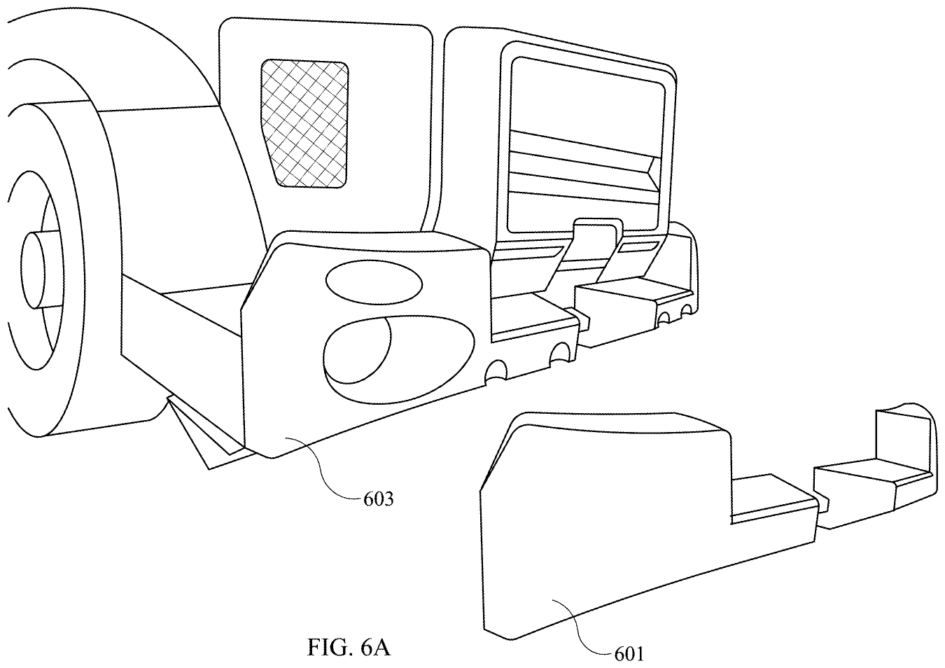

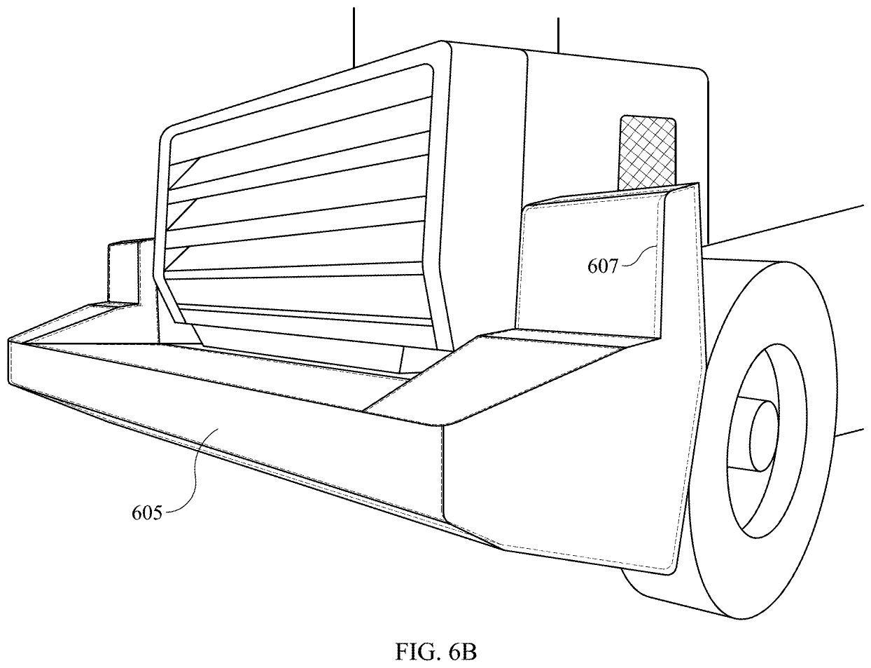

FIG. 6A is an illustration of a protective cover 601 extending over a discrete-section counterweight 603 such as on a wheel loader, in the illustrated embodiment. The protective cover 601 can have different shapes and forms when used on discrete-section counterweights in alternative embodiments. In this embodiment, the protective cover 601 is created in sections to extend over the two different portions of a discrete-section counterweight or bumper structure following the F3 design framework. As illustrated here, the protective cover 601 can be comprised of a formed material that may be clear or near translucent to enable signal lights to be displayed and to enable projection of light through the cover while the vehicle is in use. The protective cover 601 is formed into the shape of each of the discrete-section counterweights and is connected to them by any one of several possible conventional means including one or more integrated flanges, extended arms with extensions enabling the connection of the cover onto the underlying counterweight or other conventional means. The thickness of the protective cover 601 can vary and is sufficient to provide protective covering of physical damage on the discrete-section counterweights while also being capable of being shaped or formed in different ways to provide a potential variation or distinct appearance to the surface of the counterweights following the F3 design framework. The formed material used to create the protective cover is comprised of ABS, PP, HDPE, Acrylic, or other plastic compound material alternatives.

FIG. 6B is an illustration of a protective cover 605 extending over a continuous counterweight 607 of a wheel loader in an embodiment. In this illustrated embodiment, a protective cover 605 shaped in the form of the continuous counterweight extends over the counterweight 607 to provide protection from physical damage such as scratches, dents, coloration chippings, etc. or to cover physical damage (e.g., chips, cracks, etc.) on the underlying counterweight structure 607. The protective cover 605 is comprised of a formed material formed from material such as ABS, PP, HDPE, Acrylic, or other plastic compound material alternatives. The inner surface of the protective cover 605 is shaped to be similar in form to the outer surface of the structure onto which the protective cover is attached or connected. The protective cover 605 is attached using any one of a variety of conventional means including one or more flanges, extended arms running the length of the protective cover 605 that can be connected or attached to the underlying structure or other integrated connecting means. The outer surface of the protective cover 605 may preserve the underlying shape of the protected structure or be shaped or formed differently for the purpose of enhancing the physical appeal or visual appearance of the counterweight structure of a wheel loader. This form of protection is valuable as one way of improving the visual appearance or commercial resale value of such industrialized equipment. As appropriate and where desired, the protective cover 605 can include reflective material or support the mounting of lighting or other signage or embossment with desired lettering or logos. Such enhancements may be applied to or integrated into the materials forming the protective cover 605 and following the F3 design framework.

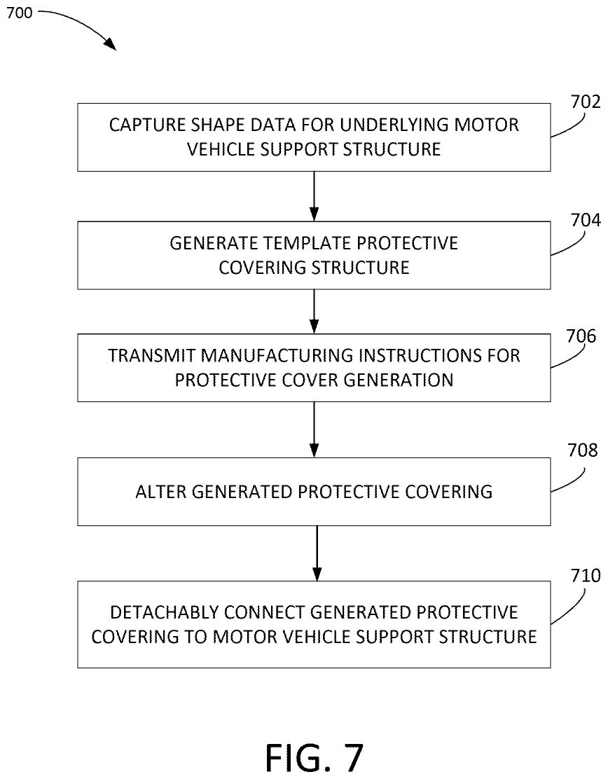

FIG. 7 is a flowchart illustrating a method of making a protective cover 700 for a vehicle in an embodiment. A protective cover is produced using a plurality of data based upon the shape of the underlying structure or object that is to be covered. In particular, shape data representing the length, width and material content of the underlying structure is captured in a data file, as shown at step 702, which is preprocessed and transmitted to a manufacturing facility for the control of manufacturing processes using a raw material, typically an industrial plastic, such as ABS, PP. HDPE, Acrylic or other plastic compound material alternatives, to first determine the amount of raw material to be used and to then perform controlled heating, cooling, and the forming and final trimming of a protective cover that substantially covers the underlying structure to which it is attached. In alternative embodiments, the materials are subjected to 3D Printing, thermomolding or thermoforming processes to produce the desired shape for the formed protective cover. After receipt of the data file, a template structure is generated, at step 704, and represented in computer-generated form and process control instructions are transmitted, at step 706, to control a manufacturing process to generate a baseline formed structure. This structure is further altered to produce a custom shaped protective covering, at step 708, based on the structure represented in data stored in the data file of the underlying structure to revise the general shape of the formed structure to a specific structure that is substantially like the underlying structure. The formed structure is generated with one or more integrated connecting features, and, upon generation, the features will enable the formed structure to be detachably connected, as shown at step 710, to the outer surface of the underlying structure for a motorized vehicle using a plurality of connecting means. These connecting means, in different embodiments, can be flanges, integrated grooves within the formed structure for slidable integrated connection onto the underlying structure, extension arms or extended sections of the formed structure that are capable of being form-fitted or snapped onto the underlying structure.

Although specific embodiments have been illustrated and described herein, it will be appreciated by those of ordinary skill in the art that a wide variety of alternate and/or equivalent implementations may be substituted for the specific embodiments shown and described without departing from the scope of the present disclosure. This application is intended to cover any adaptations or variations of the embodiments discussed herein.

What I claim is:

1. A protective cover for a motorized vehicle, the protective cover comprising:
a formed structure covering substantially all of an outer surface of the motorized vehicle, the formed structure having an outer surface and an inner surface; and
an integrated connecting means on the formed structure for connecting the formed structure to the outer surface of the motorized vehicle, the integrated connecting means detachably connecting the inner surface of the formed structure to the outer surface of the motorized vehicle,
the outer surface of the formed structure having a shape, a color or a texture substantially similar to the outer surface of the motorized vehicle.

2. The protective cover of claim 1 wherein the formed structure is comprised of a solid opaque material or a transparent material.

3. The protective cover of claim 1 wherein the formed structure covers substantially all of an outer surface of a component of the motorized vehicle.

4. The protective cover of claim 1 wherein the formed structure is comprised of a plastic compound material, the plastic compound material being at least one of Acrylonitrile Butadiene Styrene (ABS), Polystyrene, Acrylic, Polyphenylsulfone (PPSU), Polycarbonate, Polypropylene (PP), or Polyethelene (HDPE).

5. The protective cover of claim 3 wherein the component is a front bumper when the motorized vehicle is a commercial truck.

6. The protective cover of claim 5 wherein the integrated connecting means is comprised of a plurality of flanges or an extended section for slidably connecting, snapping or form fitting the protective cover onto the front bumper.

7. The protective cover of claim 1 wherein the motorized vehicle is an industrial excavator and the integrated connecting means connects the formed structure to the outer surface of a rear side of the industrial excavator, the integrated connecting means being one or more extended sections of the formed structure or a plurality of flanges.

8. The protective cover of claim 3 wherein the motorized vehicle is an industrial excavator and the component is a counterweight, a side guard or a rear counterweight of the industrial excavator, and wherein the integrated connecting means is comprised of a plurality of integrated flanges or one or more extended sections of the formed structure following a Form-Fit-Function (F3) design framework.

9. The protective cover of claim 8 wherein the plurality of integrated flanges or sections detachably connects to the component when the component is the rear counterweight and wherein the one or more extended sections of the formed structure extend over and are slidably connected or snapped onto the component when the component is the rear counterweight.

10. The protective cover of claim 3 wherein the motorized vehicle is a motor grader and the component is a forward push block or a rear protective guard, wherein the integrated connecting means is slidably connected and extended when the component is a forward push block, and wherein the integrated connecting means is a plurality of integrated flanges or one or more extended sections when the component is the rear protective guard, the integrated connecting means following a Form-Fit-Function (F3) design framework.

11. The protective cover of claim 3 wherein the motorized vehicle is a pickup truck and the component is a front bumper or a rear bumper, and wherein the integrated connecting means is a one or more integrated flanges or one or more adapted hinge extensions.

12. The protective cover of claim 3 wherein the motorized vehicle is a telescopic material handler and the component is a rear-mounted counterweight, and wherein the integrated connecting means is a plurality of integrated flanges or one or more extended sections of the formed structure, each of the one or more extended sections extending across the rear-mounted counterweight and connected to an underlying structure of the telescopic material handler, the integrated connecting means providing a fitment following a Form-Fit-Function (F3) design framework.

13. The protective cover of claim 3 wherein the motorized vehicle is a wheel loader and the component is a discrete-section counterweight or a continuous counterweight, wherein the integrated connecting means is a plurality of integrated flanges or one or more extension arms extending from the formed structure and connected onto the discrete-section counterweight, and wherein the integrated connecting means extends horizontally from the formed structure and longitudinally along the continuous counterweight, the integrated connecting means following a Form-Fit-Function (F3) design framework.

14. The protective cover of claim 1 wherein the outer surface of the formed structure has a shape, a color or a texture that is substantially different from the outer surface of the motorized vehicle.

15. The protective cover of claim 3 wherein the outer surface of the formed structure has a shape, a color or a texture that is substantially different from an outer surface of the component of the motorized vehicle.

16. A method of making a protective cover for an outer surface of a motorized vehicle, the method comprising:
forming a material into a structure covering substantially all of the outer surface of the motorized vehicle, the structure having an outer surface and an inner surface, the inner surface having a plurality of integrated connecting means;
altering the outer surface of the structure to be substantially different from the outer surface of the motorized vehicle in shape, color or texture; and
detachably connecting the structure using the plurality of integrated connecting means to the outer surface of the motorized vehicle.

17. The method of claim 16 wherein the altering of the outer surface of the structure comprises altering the outer surface of the structure to be substantially similar to the outer surface of the motorized vehicle.

18. The method of claim 16 wherein the material is comprised of a plastic compound material, the plastic compound material being at least one of Acrylonitrile Butadiene Styrene (ABS), Polystyrene, Acrylic, Polyphenylsulfone (PPSU), Polycarbonate, Polypropylene (PP) or Polyethelene (HDPE).

19. The method of claim 16 wherein the plurality of connecting means includes a plurality of flanges, one or more extended arms, an adapted hinge extension, or an extended section connected to a component mounted on the outer surface of the motorized vehicle following a Form-Fit-Function (F3) design framework

20. The method of claim 19 wherein the component is:
a front bumper of a commercial truck;
a counterweight, a rear counterweight or a side guard of an industrial excavator;
a forward push block or a rear protective guard of a motor grader;
a front bumper or a rear bumper of a pickup truck;
a rear-mounted counterweight of a telescopic material handler;
a discrete-section counterweight or a continuous counterweight of a wheel loader; or
a discrete-section counterweight or a continuous counterweight of a conventional forklift.
